(19) United States
(12) Patent Application Publication
(10) Pub. No.: US 2009/0182612 A1
(43) Pub. Date: Jul. 16, 2009

(54) SYSTEM AND METHOD FOR ONLINE SIZING AND OTHER APPLICATIONS INVOLVING A ROOT MEASURABLE ENTITY

(75) Inventors: David Carroll Challener, Raleigh, NC (US); Daryl Carvis Cromer, Cary, NC (US); Justin Tyler Dubs, Durham, NC (US); Jennifer Greenwood Zawacki, Hillsborough, NC (US)

Correspondence Address: ROGITZ & ASSOCIATES, 750 B STREET, SUITE 3120, SAN DIEGO, CA, 92101, US

(73) Assignee: Lenovo (Singapore) Pte. Ltd.

(21) Appl. No.: 11/972,162

(22) Filed: Jan. 10, 2008

(51) Int. Cl. G06F 17/00

(52) U.S. Cl. 705/10; 705/7

(57) ABSTRACT

Applications are disclosed involving root measurable entities such as given a size of a garment from one manufacturer that fits, appropriate sizes for garments made by other manufacturers can be returned; also, given a particular computer network and a user-input desire for a particular task, optimum settings are returned.

### FIELD OF THE INVENTION

The present invention relates generally to systems and methods for online sizing and other applications involving a root measurable entity.

### BACKGROUND OF THE INVENTION

In many applications there is a root measurable entity that is difficult to measure, but which people typically base decisions on via trial and error. As understood herein, once solved, other people who have the same base root measurement can use the same solutions, given that they know they have the same measurement,

For example, merely correlating, e.g., one book selection with another book simply on the basis that prior purchasers bought both books does not and is not intended to provide a definitive “right” answer to questions since recommendations as to taste are not really root measurable. In contrast, whether a particular size garment from a particular garment maker will fit, or whether particular electronics in a home entertainment center will work together or not, are root measurable because garments either fit or they don't and electronic components either function together or they don't.

In other words, as understood herein it can be difficult to assemble groups of things that work together. Returning to garment sizes, while a person has a size and shape that size and shape can be difficult to measure, much less describe. This is because doing so in the context of purchasing garments isn't as simple as simply defining a person's size to be “size 14”, because different manufacturers can mean different things by a particular size number and can assume different body shapes in tailoring their wares. Indeed, as recognized herein one of the chief reasons for returning garments particularly when purchased online is lack of a good fit.

### SUMMARY OF THE INVENTION

A system includes a user computer and a server communicating with the user computer. The server receives a garment size indication from the user computer and accesses a database containing correlations between garment sizes to return information in response to the query regarding additional garments that fit a person associated with the garment size indication from the user computer.

The correlations can be based on purchasing patterns of other users. If desired, the correlations can be based on return patterns of other users. The garment size indication may be for a garment having a first size and provided by a first garment provider, and the information in response to the query regarding additional garments may include one or more garments having a second size and provided by a second garment provider different from the first garment provider.

In another aspect, a computer has a processor receiving requests for data items from users. The processor associates transitive metadata with the data items. The metadata is defined by user-established associations between data items and is useful in determining if two data items have the same metadata. The processor assembles sets of data that all have the same metadata without knowing a priori what the metadata itself will be.

In still another aspect, a tangible computer readable medium is executable by a digital processor to receive user-defined groups of data items and to establish associations based on the user-defined groups. Associations are returned in response to a user query including a fragment of one of the groups.

The details of the present inventions both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting computer that can use the present invention;

FIG. 2 shows a non-limiting flow chart of the present logic;

FIG. 3 is a flow chart of a non-limiting example logic; and

FIG. 4 is a flow chart of another non-limiting example logic.

### DETAILED DESCRIPTION OF THE PREFERRED EMBODIMENT

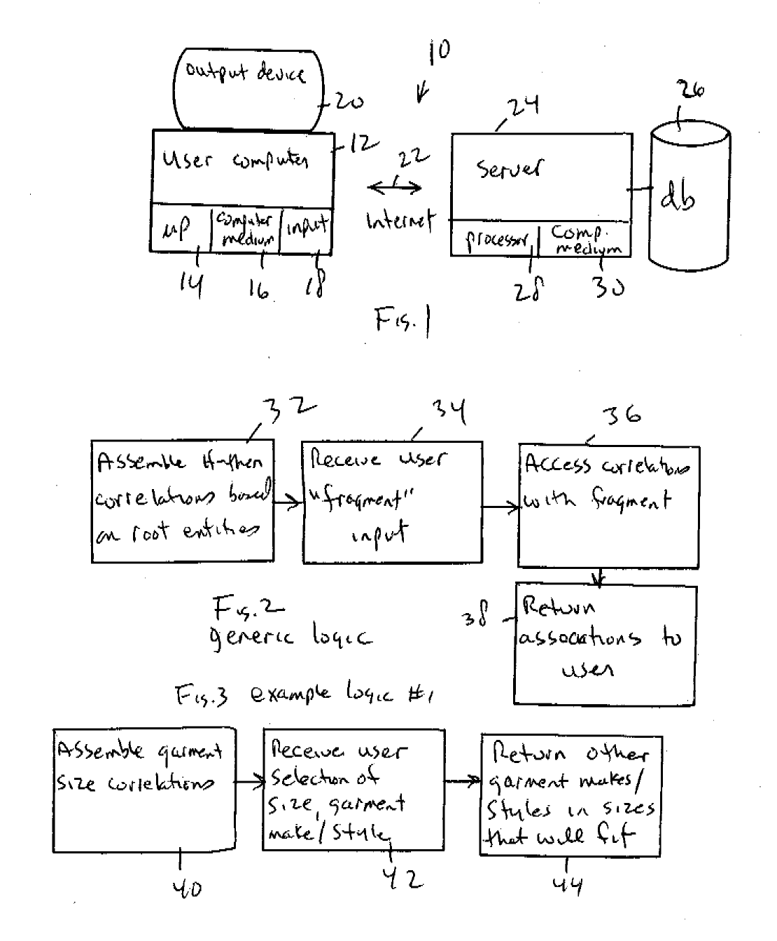

Referring initially to FIG. 1, a high-level block diagram of a data processing system, generally designated 10, is shown in which the present invention may be implemented. The system 10 in one non-limiting embodiment includes one or more user computers 12 (only one computer 12 shown for clarity) that has a processor 14 accessing a tangible computer readable storage medium 16 such as but not limited to solid state memory, disk-based memory, or a combination thereof. The computer 12 can also have one or more input devices 18 such as keyboards, keypads, mice, trackballs, joysticks, etc. and one or more output devices 20 such as computer monitors, printers, other computers, etc.

As shown, the user computer 12 can communicate over a local area network or wide area network such as the Internet 22 with a server 24 accessing a database 26 of correlations based on root measurable entities. The server 24 typically includes a server processor 28 accessing tangible computer readable storage medium 30 such as but not limited to solid state memory, disk-based memory, or a combination thereof.

FIG. 2 shows the overall logic of the present invention. As shown at block 32 and as illustrated further below, if-then correlations are assembled in, e.g., the database 26 by, e.g., the server 24 based on root measurable entities. At block 34 a user query, typically in the form of a fragment of a correlation in the database, is received from, e.g., the user computer 12, and the correlations are accessed at block 36 using the fragment as entering argument. Associations related to the fragment are then returned at block 38 from the server 24 to the user computer 12.

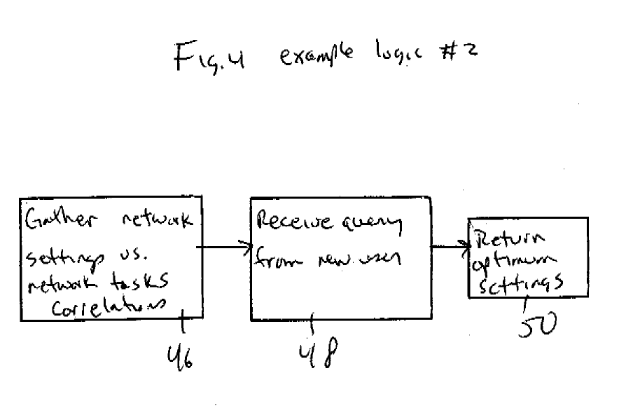

FIG. 3 shows an illustration of the principles above. Commencing at block 40, garment size correlations are assembled. These can be assembled simply by noting, for each purchaser, what group of garments the purchaser buys. For example, assume ten different types of pants that potentially fit the same person. Some types might share a common numerical size and other types might not, making the correlation problematic absent present principles.

For clarity, assume the ten different types of garments are sequentially designated “A” through “J”. Assume a first buyer purchases garments “A”, “B”, and “C” to establish a first correlation, and that a second buyer purchases garments “B”, “F”, “G”, and “H” to establish a second correlation. A third correlation can now be established using the first two, namely, that since both buyers purchased garment “B”, it can be inferred that garments “A” and “C” (from buyer #1 correlation) as well as garments “F”, “G”, and “H” (from buyer #2 correlation) would fit a subsequent purchaser of garment “B”. Furthermore, assume a third purchaser buys garments “H”, “I”, “J”, and “D”. Since buyers #2 and #3 both purchased garment “H”, it can be inferred that garments purchased by buyer #2 will fit buyer #3 and vice-versa. Combining these correlations can produce, as a recommendation to any person who subsequently buys any one of the garments “A”-“J”, all of the garments in the correlation “A”-“J”.

The above correlations can be further refined using subsequent return patterns. For example, if more than at threshold percentage of purchasers of garments “A” and “B” return garment “B” because of poor fit, then garment “B” can be removed from all correlations with garment “A”.

The above associations can be extended to shoe sizes, pants sizes, shirt sizes, dress sizes, etc, and can be modified to include provisions for color. This is because, as recognized herein, some manufacturers might have different colors of the same garment style and size made in respective different sites, potentially meaning that although being of the same size and typo garments from the same manufacturer, garments made of different colors might have shapes sufficiently different to raise an issue of fit.

Thus, in the simplest sense, if two people who both fit in the same trousers, and one fits slacks from manufacturer “A”, size 14, and the other also fits slacks size 15 from manufacturer “B”, then the first person probably fits size 15 in manufacturer “B” slacks and the second person will fit size 14 from manufacturer “A”.

It may now be appreciated that from one perspective, the data items sought by a user have associated albeit hidden metadata that is transitive. The metadata has the property that there is a means of determining if two items have the same metadata—without knowing the metadata. These two properties are used to self-assemble large sets of data that all have the same metadata without knowing a priori what the metadata itself will be.

FIG. 4 shows another illustration of present principles. Commencing at block 46, optimal network settings of a particular type of computer, e.g., a type of notebook computer, can be correlated to specific network tasks based on indications of optimal settings from users. A query from a user can be received at block 48 as to what optimum settings should be established in the user's computer, and the optimum settings returned at block 50.

Thus, for instance, a user might input a correlation indicating a type of computer, a type of operating system executed on the computer, and the fact that the following group of settings works best at a given location: access connections are used, a particular phone company dialer is used, etc. Likewise, optimal computer settings for a given computer type and host operating system type for a given location might be established for tasks that include accessing all local enterprise networks, using optimal internal tools such as MS Java, setting all passwords to be the same in a password database, and generating passwords that a given system will find acceptable under its password security rules.

As more people add data, cross-correlations become stronger, with the result that new users can increasingly find “best” answers.

Furthermore, the database 26 may be statistically mined to determine a best computer software preload suite, or what sizes to make more of, as well as to identify geographic variations in purchasing habits to be able to stock stores by geographic location optimally.

Additional benefits may be realized from present principles. For example, using the correlations an online store could direct a customer to a page custom made for that customer that displays only garments that fit the customer. Still further, user correlations can be used to implement a social networking site based on similar problems (clothes sizing) and solutions (garments that fit) to establish a network group that is an online shopping forum or online help community. In the community other users can provide recommendations of solutions that may be used for online purchases and for deciding whether to travel to local stores to confirm fit. Retailers can also use the correlations as well as which items sell best by geography to provide targeted marketing to users' Internet Protocol (IP) addresses. Retailers can also ascertain that certain clothing makers provide different fits for the same numerical size, and can adjust size information in websites and other marketing sources accordingly.

As yet a third example of present principles, the example shown in FIG. 4 can be modified to generate, based on user-defined associations, recommendations as to whether particular electronic components will work with other identified components in a home network.

While the particular SYSTEM AND METHOD FOR ONLINE SIZING AND OTHER APPLICATIONS INVOLVING A ROOT MEASURABLE ENTITY is herein shown and described in detail, it is to be understood that the subject matter which is encompassed by the present invention is limited only by the claims.

What is claimed is:

1. A system comprising:
a user computer;
a server communicating with the user computer and receiving a garment size indication therefrom, the server accessing a database containing correlations between garment sizes to return information in response to the query regarding additional garments that fit a person associated with the garment size indication from the user computer.

2. The system of claim 1, wherein the correlations are based on purchasing patterns of other users.

3. The system of claim 2, wherein the correlations are based on return patterns of other users.

4. The system of claim 1, wherein the garments are pants.

5. The system of claim 1, wherein the garment size indication is for a garment having a first size and provided by a first garment provider, and the information in response to the query regarding additional garments includes at least one garment having a second size and provided by a second garment provider different from the first garment provider.

6. A computer, comprising:
at least one processor receiving requests for data items from users;
the processor associating transitive metadata with the data items, the metadata being defined by user-established associations between data items, the metadata being useful in determining if two data items have the same metadata, the processor assembling sets of data that all have the same metadata without knowing a priori what the metadata itself will be.

7. The computer of claim 6, wherein the processor accesses a database containing associations between data items, the associations establishing the metadata.

8. The computer of claim 7, wherein the processor receives a garment size indication from a user computer and the associations are between garments fitting a single person, the processor returning information regarding additional garments that fit a person associated with the garment size indication from the user computer.

9. The computer of claim 6, wherein the associations are based on purchasing patterns of plural users.

10. The computer of claim 6, wherein the associations establish a root measurable entity.

11. The computer of claim 9, wherein the associations are based on return patterns of other users.

12. The computer of claim 8, wherein the garments are pants.

13. The computer of claim 8, wherein the garment size indication is for a garment having a first size and provided by a first garment provider, and the information in response to the query regarding additional garments includes at least one garment having a second size and provided by a second garment provider different from the first garment provider.

14. The computer of claim 6, wherein at least one association includes user-defined network settings of a particular type of computer correlated to one or more specific network tasks.

15. A tangible computer readable medium executable by a digital processor to:
receive user-defined groups of data items;
establish associations based on the user-defined groups; and
return at least one association in response to a user quay including at least a fragment of one of the groups.

16. The tangible computer readable medium of claim 15, wherein the processor receives a garment size indication from a user computer and the associations are between garments fitting a single person, the processor returning information regarding additional garments that fit a person associated with the garment size indication from the user computer.

17. The tangible computer readable medium of claim 16, wherein the associations are based on purchasing patterns of plural users.

18. The tangible computer readable medium of claim 17, wherein the associations are based on return patterns of other users.

19. The tangible computer readable medium of claim 18 wherein the garment size indication is for a garment having a first size and provided by a first garment provider, and the information in response to the query regarding additional garments includes at least one garment having a second size and provided by a second garment provider different from the first garment provider.

20. The tangible computer readable medium of claim 15, wherein at least one association includes user-defined network settings of a particular type of computer correlated to one or more specific network tasks.
